(19) United States
(12) Patent Application Publication
(10) Pub. No.: US 2010/0296519 A1
(43) Pub. Date: Nov. 25, 2010

(54) Ethernet Physical Layer Repeater

(75) Inventor: Michael Jones, Newport (GB)

Correspondence Address: PATENT LAW GROUP LLP, 2635 NORTH FIRST STREET, SUITE 223, SAN JOSE, CA, 95134, US

(73) Assignee: MICREL, INC.,, San Jose, CA (US)

(21) Appl. No.: 12/470,368

(22) Filed: May 21, 2009

(51) Int. Cl. H04L 12/66; G06F 15/16; H04J 3/08

(52) U.S. Cl. 370/463; 709/209; 370/501

(57) ABSTRACT

An Ethernet repeater system has a plurality of identical repeaters which add substantially no delay. Each repeater has at least a first port and a second port connected to a medium, and a third port connected to a slave processor or a master processor. The master processor controls all communications on the medium. A receive multiplexer always applies data on the medium to the processor in the event the data is destined for the processor. A first transmit multiplexer has inputs connected to the second port and the processor, and an output connected to the first port. A second transmit multiplexer has inputs connected to the first port and the processor, and an output connected to the second port. The first and second transmit multiplexers act as a bridge between the first and second ports to pass through data without any variable latency since the data does not have to be buffered.

### FIELD OF THE INVENTION

This invention relates to Ethernet networks and, in particular, to a repeater for Ethernet data that adds minimal, fixed latency so timing of data to and from devices on the network can be precisely controlled.

### BACKGROUND

Repeaters are known for use in Ethernet networks. Some repeaters only amplify and reshape digital signals so the signals may be transmitted long distances. However, if a repeater is required to perform additional tasks while or before repeating the data along the medium (e.g., twisted pair wires), such repeaters contain buffers for temporarily storing the data while the data is processed. There are varying and unpredictable latencies involved in such “intelligent” repeaters. These “intelligent” repeaters are often referred to as “switches.” For normal Ethernet communications, the typical variable latencies in incurred by the repeater for the processing or re-transmission of packets have no adverse effects since the use of the data does not involve critically-time events.

Typically, for time-critical Ethernet communications, only one computer can use the medium at a time, so access to the medium must be coordinated. Such coordination also adds a variable and unpredictable latency between the communication of data between computers in the network.

In certain applications, such as the coordinated control of computer-controlled robots in an assembly line, any varying latency in communicating with the robots using a master controller creates a problem, since the timing of all the robots' actions should be synchronized. If the robots' computers were connected along an Ethernet network, and each node had a repeater, the repeater must not add any variable latency. A minimal fixed latency is a goal to improve real-time performance, since the latency would be already known and accounted for.

What is needed is an Ethernet repeater for use at a node that can pass data to a processor (e.g., a robot's processor) at the node and also repeat the data along the medium without buffering the data (reducing latency) and without creating a varying latency. Removing the data buffering also has the added advantage of reducing the costs.

### SUMMARY

The present invention is particularly useful in applications where devices must be controlled in real time via an Ethernet network, since any latency along the medium will be very small and fixed.

An Ethernet network is disclosed that includes a master repeater and a plurality of slave repeaters. Each repeater is the same, but the master repeater is connected to a master processor that coordinates all communication on the medium. Each slave processor may control a robot on an assembly line or control any other device. The master processor may also be the master controller for all the slave processors, not just control communications on the medium. The master processor may also control its own associated robot or other device.

The master repeater and slave repeaters are connected in series along an Ethernet medium. Ethernet mediums include coax, twisted pair, optical cable, and any other suitable medium. In the Ethernet protocol, packets are transmitted along the medium, and the computers along the medium are coordinated to not transmit at the same time. Packets may be addressed to one particular computer, or packets may be broadcast to all or multiple computers.

The repeaters only operate at the physical layer in the Ethernet network.

Each repeater has a port 1 connected to a medium segment, a port 2 connected to another medium segment, and a port 3 connected to the processor associated with the repeater (a slave or master processor).

Each repeater contains at least two transmit multiplexers. The first transmit multiplexer has one input connected to port 2 and a second input connected to the output of the processor. The second transmit multiplexer has one input connected to port 1 and a second input connected to the output of the processor. The transmit multiplexers automatically detect if incoming data is being transmitted on the medium or being generated by its processor. Once the multiplexer senses the source of the data, the multiplexer automatically passes that data to its output and is only reset once the transmission is over.

The repeater also contains a receive multiplexer, having its inputs connected to the ports 1 and 2 and its output connected to the input of the processor. Once the receive multiplexer senses the source of the data, the multiplexer automatically passes that data to its output and is only reset once the transmission is over.

All the multiplexers operate independently from one another.

The master processor controls all communications on the network. The master processor can send control data to any slave processor to cause the slave processor to control its robot accordingly or perform any other function. The master processor also initiates a transmission by one of the slave processors by sending an invite signal to the slave processor. The slave can communicate with any other slave and with the master. Such communications have no varying latency since only the master processor controls the master-to-slave and the slave-to-master communications and, as seen below, there is no additional latency in pass-through by the repeaters. There will always be some delay going through silicon circuits but it is negligible.

When there are packets on the medium, generated by a slave or master processor, each slave repeater must pass the packets on to the next slave repeater so that all the slave processors can receive the packets. The multiplexer arrangement in the repeaters does not create a variable latency when the signals on the medium are repeated. This is because, when there is a packet on the medium, the appropriate transmit multiplexer effectively connects the ports 1 and 2 together without the data having to be buffered or delayed for processing. Simultaneously with the transmit multiplexers bridging the ports 1 and 2, the data is also being transmitted to the associated processor via the receive multiplexer and port 3 in case the data is intended for that processor.

Therefore, each repeater can pass data through the repeater with substantially no latency, the data is simultaneously applied to a processor associated with each repeater with substantially no latency, and the master processor controls all the communications so all tasks carried out by the slave processors are precisely timed with no unknown latencies. The cost of each repeater is low since there is no buffer memory or processing performed by the repeater.

Each repeater contains an appropriate serial front end (SFE) interface at ports 1 and 2 to perform any standard interface function, but at the Ethernet bit speed so that there is substantially no latency. The SFE will add some bit delay as it has to lock onto incoming data and reclock it out. However, this is minimal.

The invention may be used for any network where unknown latencies are to be avoided.

### BRIEF DESCRIPTION OF THE DRAWINGS

FIG. 1 illustrates an Ethernet network including a medium, a plurality of repeaters connected in series, with a processor connected to each repeater, where one processor is a master processor for controlling access to the medium.

FIG. 2 illustrates one of the repeaters connected between the medium and a processor.

FIG. 3 illustrates more detail of the serial front end (SFE1 or SFE2) and the parallel back end (PBE) in FIG. 2.

FIG. 4 is a diagram illustrating one embodiment of a multiplexer used in the repeater.

FIG. 5 is a flowchart showing various steps in the inventive technique.

Elements labeled with the same numeral may be equivalent or identical.

### DETAILED DESCRIPTION

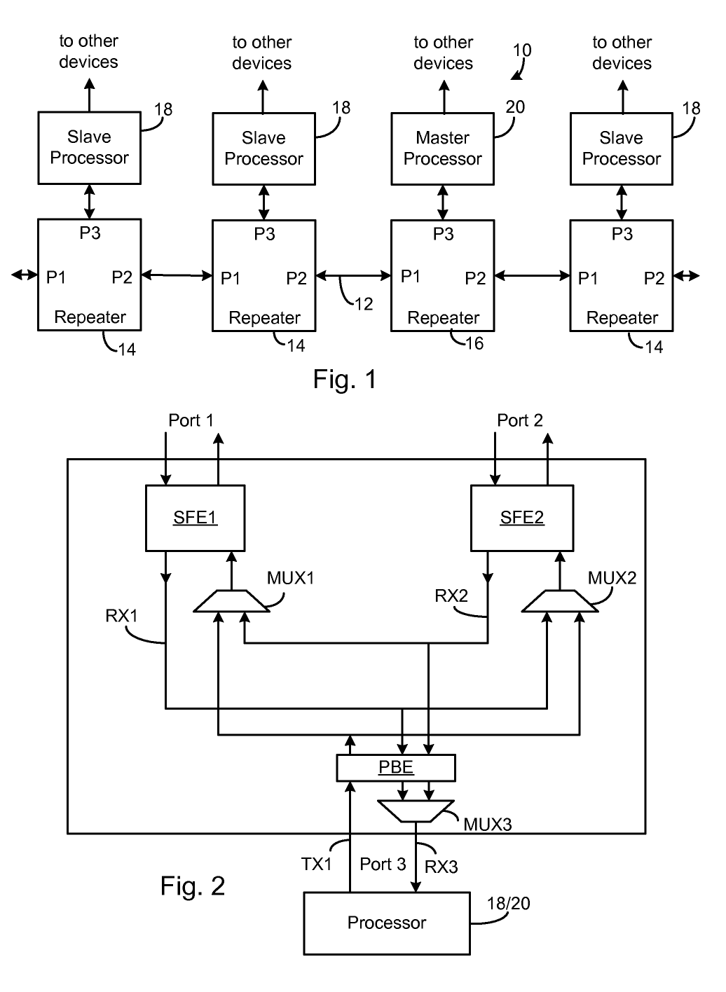

FIG. 1 illustrates an Ethernet network 10 incorporating the present invention. In one embodiment, the network controls robots in an assembly line where the actions of the robots need to be coordinated in real time. Although the example of an assembly line is used during the explanation, the network may be used for any application.

The medium 12 will typically be a twisted pair carrying differential signals. Optical fibers may also be used for Ethernet speeds 100 Mbps and above. The invention is not limited to just twisted pair and fiber, since any suitable medium could be used. Identical repeaters connect together segments of the medium. In FIG. 1, there are three slave repeaters 14 and one master repeater 16. Ports are labeled P1, P2, and P3 for ports 1, 2, and 3, respectively. Each repeater can simultaneously pass through signals between its ports 1 and 2 with minimal fixed latency and forward the signals to its processor without latency. The slave repeaters 14 are connected to an associated slave processor 18, and the master repeater 16 is connected to a master processor 20.

Each processor 18/20 may control another device, such as a robot, an audio/video device, a transportation device, or any other device where substantially real time control is desired.

FIG. 2 illustrates functional elements in an embodiment of each repeater 18/20. Ports 1 and 2 are connected to the twisted pair differential wires (or any other medium). In one embodiment, there is a set of twisted pair wires for transmitting from a repeater and another set of twisted pair wires for receiving.

The default setting for MUXes 1 and 2 is pass-through mode. This is all performed on serial data and not converted to 4-bit parallel (MII). This reduces cost but most importantly reduces latency. The pass-through latency is the critical delay as sending data across network will result in N×pass-through delay+single port 1 or 2 to port 3 delay, where N is the number of node on the chain.

Standard serial front end interfaces, SFE1 and SFE2 will recover the 125 MHz line clock in the receive direction and clock out using the 125 MHz clock it receives with the data from MUX1 and MUX2 in the transmit direction. The SFE1 and SFE2 interfaces receive serial bits from the ports 1 and 2 and are connected to serial RX1 and RX2 buses in the repeater.

The overall circuit operates at the physical layer (PHY). As is well known and conventional, a PHY interface converts the signaling on the Ethernet medium to a bit stream that may be recognized by a processor, and visa versa. For example, the PHY interface may convert between differential signals and the non-differential MII bus signals, modulate/demodulate, encode/decode, amplify, pulse shape, add start/stop signaling, perform error correction, perform filtering, and perform any other standard physical layer interface functions well known to those skilled in the art. Such functions are identified in appropriate IEEE standards, incorporated by reference, and such functions are not shown in the figures for simplicity since such functions are not related to the invention. Such interfaces typically do not use microprocessors, but use hardware, so that the interfaces operate at the necessary bit speeds to not add latency.

There are two transmit multiplexers, MUX1 and MUX2. MUX1 has one input connected to receive data from port 2 (via the RX2 bus) and another input connected to receive data from the processor 18/20 (via the TX1 bus). The output of MUX1 transmits data to port 1. MUX2 has one input connected to receive data from port 1 (via the RX1 bus) and another input connected to receive data from the processor 18/20 (via the TX1 bus). The output of MUX2 transmits data to port 2.

A receive MUX3 has one input connected to receive data from port 1 (via the RX1 bus) and another input connected to receive data from port 2 (via the RX2 bus). The output of MUX3 transmits data to port 3 (via the RX3 bus), which is an input to the processor 18/20.

In one embodiment, a serial-parallel converter within a parallel back end (PBE) converts serial data (including a clock) on the RX1 and RX2 buses to a parallel format (MIT) for application to the processor 18/20. Conversely, the PBE converts the parallel format data from the processor 18/20 into a serial format for application to the RX1 and RX2 buses.

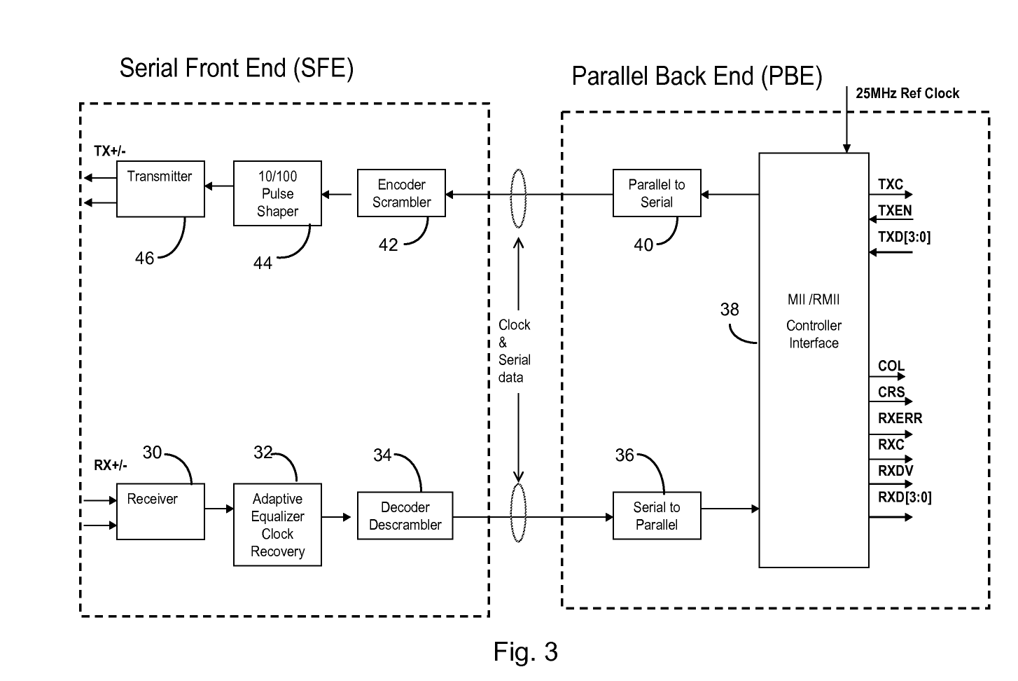

FIG. 3 provides more detail of possible circuitry in the SFE1 (or SFE2) and the PBE. The circuitry between the SFE and PBE from FIG. 2 is not shown in FIG. 3. A receiver 30 receives serial data from port 1 or port 2. The signal is equalized and the clock is recovered by the adaptive equalizer/clock recovery circuit 32. The signal is then decoded and descrambled by the decoder/descrambler 34. The serial signal is applied to the buses as shown in FIG. 2. The serial data is converted to parallel data by a serial to parallel converter 36 and applied to a standard controller interface 38 that converts an MII format to an RMII format for application to the processor 18/20. The signals shown at the output of the interface 38 are standard signals using conventional designations and do not need to be further described. The process is reversed for parallel data from the processor 18/20 being converted to serial data for application to the ports 1 and 2 using interface 38, parallel to serial converter 40, encoder/scrambler 42, 10/100 pulse shaper 44, and transmitter 46.

The pass-through multiplexers MUX1 or MUX2 connect the serial receive output of the SFE to the serial transmit input of the SFE when in the pass-through state (which is the MUX default state). There is virtually no latency since the SFE operates at the data rate of the Ethernet and there is no buffering. Operating on the pass-through data in the serial format, rather than in a parallel format, further reduces latency since no time is spent in the conversion process.

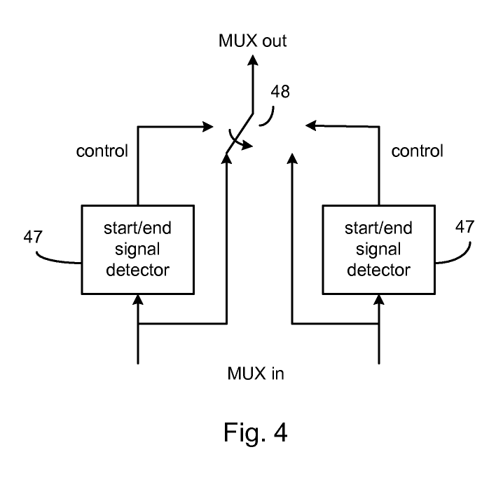

FIG. 4 illustrates the functional construction and operation of each multiplexer MUX1, MUX2, and MUX3. The multiplexer automatically senses the presence of data at an input and connects that input to its output for the duration of the transmission. The multiplexer effectively connects recovered serial data and clock from one port to the other port. In the example of FIG. 4, a start/end detector 47 receives the signal at one input of the multiplexer and determines whether the signal is a start-of-frame-delimiter (SFD), which is a 1 byte alternating pattern of ones and zeros, ending in two consecutive 1-bits, indicating that the next bit is the leftmost bit in the leftmost byte of the destination address of a packet. This signals the start of a packet after the packet's preamble. Such an SFD is defined in the IEEE 802.3 standard. Other signals indicating the start of a packet may also be used, such as J/K symbols (for 100 BT traffic) or a carrier sense signal (CRS). A simple matching circuit in the detector 47 may detect the start code of a packet. When the multiplexer detects the start of a packet at an input, the multiplexer controls a transistor switch 48 (one for each conductor of the bus) to couple that active input to the multiplexer's output until the transmission is completed. The multiplexer resets the connection when it detects an end-of-stream delimiter, or T/R symbols, or Idle symbols (for 100 BT traffic), or CRS. The reset state is the pass-through state.

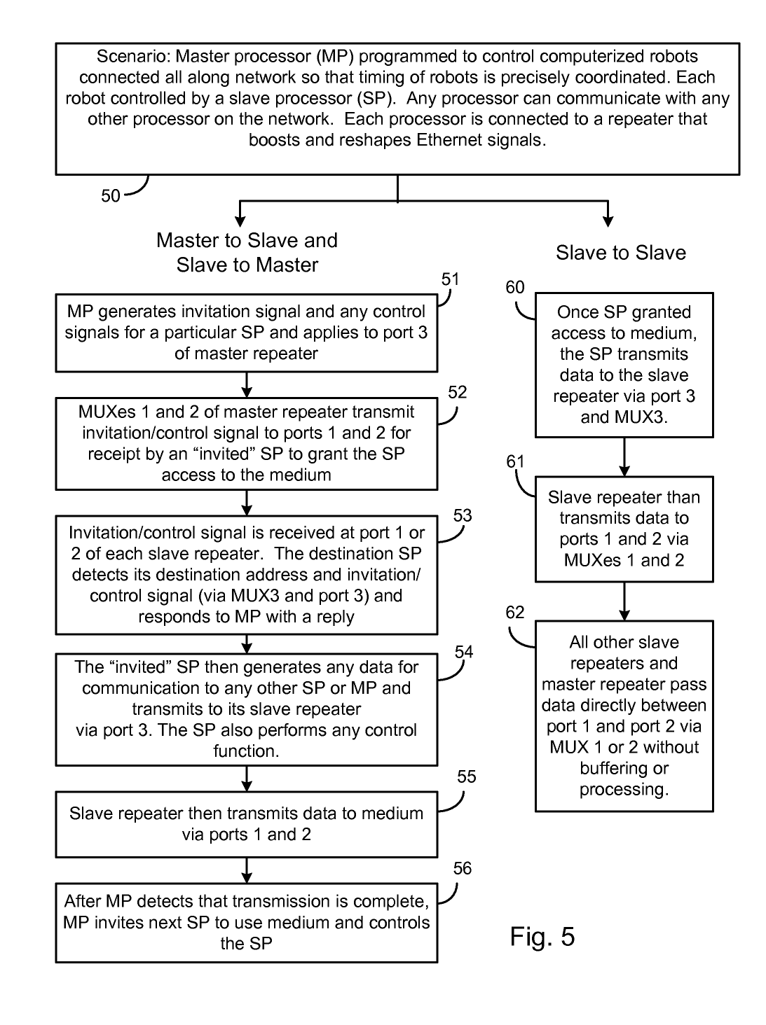

One embodiment of the operation of the various processors and repeaters is summarized in the flowchart of FIG. 5.

In step 50 of FIG. 5, it is assumed that the master processor 20 is programmed to control computerized robots connected all along the network in an assembly line so that the timing of the robots is precisely coordinated. Each robot is controlled by a slave processor 18. Any processor 18/20 can communicate with any other processor on the network. Each processor 18/20 is connected to a repeater that recovers and retimes Ethernet signals.

Since the communications on the medium are controlled by the master processor 20, all communications are initiated by the master processor 20 in accordance with a program stored in a memory accessed by the master processor 20. The transmission by the master processor 20 may be a control message to a slave to carry out a process or an invitation to the slave to transmit data to the master processor 20 or to any other slave processor 18. The slaves are in a listen mode until directed by the master to do otherwise.

Steps 51-56 describe master-to-slave and slave-to-master communications.

In step 51, the master processor 20 generates an invitation signal for a particular slave processor 18. The invitation signal will be a packet conveying the invitation signal and having the destination address of the target slave processor 18. The signal may instead be a control signal that instructs the slave processor 18 to control its robot accordingly or for another control function.

In step 52, the signal from the master processor 20 is applied to the MUXes 1 and 2 via port 3 and the TX1 bus of the master repeater 16, and the MUXes 1 and 2 automatically apply the signal to the ports 1 and/or 2 via the SFE1 and SFE2. The processor 18/20 could broadcast to ports 1 and 2 or, if “intelligence” were added to the repeater or processor and it learns where the destination devices are on network, the repeater could send data specifically to one port. Since all communication are coordinated by the master processor 20, there would have been no existing traffic on the medium 12.

In steps 53 and 54, the invitation/control signal is received by all the slave repeaters 18 at their port 1 or 2. The receive MUX3 receives the signal from either port 1 or port 2, via the RX1 or RX2 bus, and forwards the signal to its output at port 3 for receipt by its slave processor 18. The slave processor 18 looks at the destination address and, if it matches the slave processor's address, the slave processor 18 will carry out the received instructions. An alternative approach is to add a filter in the repeater to only pass packets with a specific MAC destination address. This will reduce overhead in the processor. The invention is transparent to whichever approach is taken. If the received signal is an invitation to transmit on the medium 12, the slave processor 18 will begin transmitting any data onto the medium. The data may be addressed to any one, some, or all of the processors 18/20. One type of information transmitted by a slave may be status information.

In step 55, the data on the TX1 bus from the slave processor 18 is then applied to the MUXes 1 and 2, which both forward the data to their associated port 1 and/or port 2. There would have been no existing traffic on the medium at that time, since the master processor 20 controls the traffic, so there would have been no signal on the RX1 or RX2 buses. All processors 18/20 on the network receive the transmission, but only the processor 18/20 matching the destination address in the packet acts on the data.

In step 56, after the master processor 20 detects that the transmission is complete, such as by detecting no signal on the medium, or being sent a “finished” message from the transmitting processor, or by detecting a code that signifies an end to the transmission, the master processor 20 may then invite another slave processor 18 to communicate or may send another control signal to a slave processor 18.

Since the master processor 20 coordinates all communications on the network, the master processor 20 can precisely control the timing of all control signals and communications to, from, and between the slave processors 18.

When there is traffic on the medium, there cannot be any variable latency caused by the repeaters 14/16 passing the data between ports 1 and 2. FIG. 5 includes another flowchart describing the pass-through function of the repeaters 14/16 that is performed when there is traffic on the medium 12.

In steps 60 and 61, once a slave processor 18 is granted access to the medium, the slave processor 18 then transmits the requested data to the medium via the MUX1, MUX2, SFE1, SFE2, and ports 1 and/or 2, as previously described.

In step 62, the MUX1 or MUX2 that receives the signal on the medium from port 1 or port 2 then forwards the signal onto the other port 1 or 2 to effectively bridge the two ports. During such traffic on the medium, there will be no conflicting signal transmitted on the TX1 bus in the receiving repeaters. This function is referred to as pass-through. There is virtually no buffering involved (there will be some trivial buffering needed in the clock and data recovery circuits, but such buffering adds only trivial fixed latency), and the serial front end operations performed by the SFE1 and SFE2 interfaces operate at the bit speed so there is only minimal delay. Pass-through is all done with serial data and clock. Although the repeaters 14/16 pass through data to cause all nodes to receive the packet(s), the packets are also being concurrently forwarded, via MUX3, to the processors 18/20 so the destination processor can process the data. All multiplexers in the repeaters 14/16 only have traffic at one input at a time so there is no conflict.

Since the master processor 20 initiates communication from a slave processor 18, the master processor 20 does not necessarily have to pass through any response from the slave since the destination address will be the master processor's address.

In the event that a multiplexer blocks a transmission applied to one of its inputs due to its other input signaling being active, the master processor 20 may be programmed to detect the blockage of the transmission and request a retransmit. Alternatively, receive-acknowledgement messages may be used.

The master processor 20 can control the slave processors 18 in any manner suitable for the application. The system is particularly suitable for networks that benefit from guaranteed substantially real time control with no variable latencies, such as where the nodes in a network must perform coordinated functions, such as on an assembly line. If there is any fixed latency, such latency can be compensated for by the master processor 20. The invention also minimizes the total latency, which is also important for real time events, alarms etc.

The slave and master processors 18/20 may be programmed to carry out independent operations without communicating on the medium. The communications may be just simple start and stop control data and status data. The present invention can be used for any type of communications and is primarily concerned with controlling and passing-through traffic on the medium via the repeaters. No complex switching and medium usage protocols are required, which enable real time control of the slaves.

In one embodiment, the master processor 20 is at an end of the medium so transmissions from the master processor 20 only need to flow in one direction on the medium. In such a case, the master processor 20 does not need to be connected to a repeater.

Each repeater may have more than two ports, such as in the case where the repeater is a node for a branch.

The term “connected,” as used herein when referring to components being connected to each other, is to be construed as either being directly connected or connected via additional circuitry, such as amplifiers or other interfaces, such as a physical layer interface.

Having described the invention in detail, those skilled in the art will appreciate that, given the present disclosure, modifications may be made to the invention without departing from the spirit and inventive concepts described herein. Therefore, it is not intended that the scope of the invention be limited to the specific embodiments illustrated and described.

What is claimed is:

1. A method performed by nodes in an Ethernet network, at least one node comprising a first slave processor accessing a medium via a first slave repeater, the first slave repeater comprising a plurality of ports including at least a first port and a second port connected to the medium and a third port connected to the first slave processor, the method comprising:
transmitting first data by a master processor onto the medium;
receiving the transmitted first data at the first port of the first slave repeater;
forwarding the first data received at the first port of the first slave repeater to a first input of a receive multiplexer in the first slave repeater;
forwarding, by the receive multiplexer, the first data to the first slave processor connected to the third port of the first slave repeater;
concurrently with forwarding the first data to the first slave processor by the receive multiplexer, passing through the first data between the first port and the second port of the first slave repeater via at least one transmit multiplexer so that the first data continues to travel down the medium for receipt by other slave repeaters and slave processors; and
receiving by a destination slave processor the first data via the destination slave processor's repeater, and acting on the first data by the destination slave processor,
wherein the master processor coordinates communications by the slave processors, and wherein passing through the first data between the first port and the second port of the first slave repeater is performed without variable delays requiring buffering.

2. The method of claim 1 wherein the master processor access the medium via a master repeater, and wherein transmitting the first data by the master processor onto the medium comprises:
transmitting the first data by the master processor to an input of the master repeater; and
applying the transmitted first data to a first input of at least a first transmit multiplexer and a second transmit multiplexer in the master repeater, each transmit multiplexer forwarding the first data to an associated port of the master repeater onto the medium.

3. The method of claim 1 wherein forwarding the first data received at the first port of the first slave repeater to the first input of the transmit multiplexer in the first slave repeater comprises forwarding the first data through a physical layer interface between the medium and the transmit multiplexer in the first slave repeater.

4. The method of claim 1 wherein passing through the first data between the first port and the second port of the first slave repeater comprises passing the first data through a physical layer interface between the medium and the first and second ports.

5. The method of claim 1 wherein the first port receives data from an output of a first transmit multiplexer in the first slave repeater, and the second port receives data from an output of a second transmit multiplexer in the first slave repeater,
the first transmit multiplexer having a first input connected to receive data from the second port, and having a second input connected to receive data from the first slave processor;
the second transmit multiplexer having a first input connected to receive data from the first port, and having a second input connected to receive data from the first slave processor;
wherein the first transmit multiplexer connects either its first input or its second input to its output depending on detection of a signal at either its first input or second input; and
wherein the second transmit multiplexer connects either its first input or its second input to its output depending on detection of a signal at either its first input or second input.

6. The method of claim 1 wherein the receive multiplexer has a first input connected to receive data from the first port, has a second input connected to receive data from the second port, and has an output connected to the slave processor,
wherein the receive multiplexer connects either its first input or its second input to its output depending on detection of a signal at either its first input or second input.

7. The method of claim 1 further comprising a plurality of slave processors connected to the medium via an associated slave repeater, wherein each slave repeater is identical to the first slave repeater and operated identically.

8. The method of claim 1 further comprising the first slave processor controlling a device whose actions are coordinated by the master processor.

9. An Ethernet repeater system comprising:
a first repeater having a plurality of ports comprising at least a first port and a second port connected to a medium and a third port connected to a first processor;
the first repeater comprising:
a receive multiplexer having a first input connected to receive data from the first port and having a second input connected to receive data from the second port, an output of the receive multiplexer being connected to the third port;
a first transmit multiplexer having a first input connected to receive data from the second port and having a second input connected to receive data from the third port, an output of the first transmit multiplexer being connected to transmit data to the first port; and
a second transmit multiplexer having a first input connected to receive data from the first port and having a second input connected to receive data from the third port, an output of the second transmit multiplexer being connected to transmit data to the second port,
wherein the receive multiplexer, the first transmit multiplexer, and the second transmit multiplexer forward data applied to their respective first input terminal to their respective output terminal when it is detected that data is being received at their respective first input terminal, and forward data applied to their respective second input terminal to their respective output terminal when it is detected that data is being received at their respective second input terminal.

10. The system of claim 9 wherein the first processor is a first slave processor, the system further comprising a plurality of repeaters identical to the first repeater, some of the repeaters having a slave processor connected to their third port, and one of the repeaters having a master processor connected to its third port, the master processor controlling communications on the medium.

11. The system of claim 9 further comprising a first serial interface connected between the output of the first transmit multiplexer and the first port, and comprising a second serial interface connected between the output of the second transmit multiplexer and the second port, such that pass-through of data between the first port and the second port is always performed with serial data.

12. An Ethernet repeater comprising:
at least a first port and a second port for connection to a medium and a third port for connection to a processor;
a receive multiplexer having a first input connected to receive data from the first port and having a second input connected to receive data from the second port, an output of the receive multiplexer being connected to the third port;
a first transmit multiplexer having a first input connected to receive data from the second port and having a second input connected to receive data from the third port, an output of the first transmit multiplexer being connected to transmit data to the first port; and
a second transmit multiplexer having a first input connected to receive data from the first port and having a second input connected to receive data from the third port, an output of the second transmit multiplexer being connected to transmit data to the second port,
wherein the receive multiplexer, the first transmit multiplexer, and the second transmit multiplexer forward data applied to their respective first input terminal to their respective output terminal when it is detected that data is being received at their respective first input terminal, and forward data applied to their respective second input terminal to their respective output terminal when it is detected that data is being received at their respective second input terminal.

13. The repeater of claim 12 further comprising a first serial interface connected between the output of the first transmit multiplexer and the first port, and comprising a second serial interface connected between the output of the second transmit multiplexer and the second port, such that pass-through of data between the first port and the second port is always performed with serial data.
